(19) United States
(12) Patent Application Publication
(10) Pub. No.: US 2020/0072951 A1
(43) Pub. Date: Mar. 5, 2020

(54) ROTATING PLATE UNIT AND PRODUCTION METHOD

(71) Applicant: Robert Bosch GmbH, Stuttgart (DE)

(72) Inventor: Alexander Greiner, Reichenbach (DE)

(21) Appl. No.: 16/537,749

(22) Filed: Aug. 12, 2019

(30) Foreign Application Priority Data
Aug. 30, 2018 (DE) 102018214741.8

(51) Int. Cl. G01S 7/481

(52) U.S. Cl. CPC G01S 7/4817

(57) ABSTRACT

A rotating plate unit for a LiDAR device includes a disk-shaped stator and disk-shaped rotor with respective disk-shaped surfaces that are parallel to and at a distance from each other along a central axis; and a contactless transmission system between the stator and the rotor, which has pairs of mutually corresponding transmission elements, a first transmission element of a respective pair being situated on the surface of the stator facing the rotor and the associated second transmission element of the respective pair in each case being situated on the surface of the rotor facing the stator, the mutually corresponding transmission elements of a pair being at least sectionally situated at a distance and across from each other during a rotation of the rotor; the pairs of individual transmission elements of the transmission system being situated in spatial separation from one another along the radius of the rotating plate unit.

### CROSS-REFERENCE TO RELATED APPLICATIONS

The present application claims priority under 35 U.S.C. § 119 to DE 10 2018 214 741.8, filed in the Federal Republic of Germany on Aug. 30, 2018, the content of which is hereby incorporated by reference herein in its entirety.

### FIELD OF THE INVENTION

The present invention relates to a rotating plate unit as well as a method for producing a rotating plate unit. In particular, the present invention relates to a rotating plate unit for a LiDAR device having a contactless transmission system between a stator and a rotor. In addition, it also relates to a method for producing such a rotating plate unit.

### BACKGROUND

Over the next few years, LiDAR devices are expected to become established in the realization of automated driving functions. To cover large horizontal detection angles between 150° and 360°, only mechanical laser scanners are known at present. In a first form, i.e., the rotary mirror laser scanners whose maximum detection range is limited to approximately 150°, only a motor-driven deflection mirror is rotating. For larger detection ranges of up to 360°, all electro-optical components are situated on a motor-driven rotating plate or rotor. Further electronic components are disposed on an associated stator for the most part. The stator and rotor jointly form a rotating plate unit.

The operation of a motor-driven rotating plate requires the transmission of data and energy between the stator and rotor. In addition, a transmission of the current angle of rotation of the rotating plate can be necessary. Such a transmission is mostly carried out via slip rings integrated into the rotating plate unit, which, however, allow only rotational speeds of <600 rpm. Higher rotational speeds require a contactless transmission technology. However, one disadvantage of known contactless transmission elements is their susceptibility to electrical disturbances and also, in a compact array of different transmission elements, a tendency to mutual crosstalk. In addition, an extremely precise mutual alignment of transmission elements associated with each other on the stator and rotor is required. As a result, a compact integration of a multitude of contactless transmission elements into a rotating plate unit for high rotational speeds (>600 rpm) poses a technical challenge.

### SUMMARY

According to an example embodiment of the present invention, a rotating plate unit for a LiDAR device includes: a disk-shaped stator and a disk-shaped rotor, the disk-shaped surfaces of the stator and rotor being situated parallel to and at a distance from each other along a central axis; and a contactless transmission system between the stator and rotor, which has a plurality of pairs of mutually corresponding transmission elements, in particular for the transmission of data, energy, and/or angles of rotation, a first transmission element of a respective pair being situated on the surface of the stator facing the rotor, and the associated second transmission element of the respective pair being situated on the surface of the rotor facing the stator. The transmission elements of a corresponding pair are at least regionally situated across and at a distance from each other during a rotation of the rotor, and the pairs of individual transmission elements of the transmission system are situated in spatial separation from one another along the radius of the rotating plate unit.

More specifically, a corresponding combination of stator and rotor can involve two disk-shaped elements, which are developed in axial symmetry in each case and have identical diameters, the respective axes of symmetry in a system of stator and rotor according to the present invention coinciding with the central axis of the rotating plate unit. The stator and rotor preferably have a disk-shaped development as circular ring structures. For example, the inner opening of the annuli can be developed to accommodate a shaft or a ball bearing. Preferably, the rotor can also have a disk-shaped design having a full circle-shaped structure with a monolithically developed central shaft element. Via the ball bearings, the shaft element is then able to be directly connected to a disk-shaped stator as circular ring structures. The special advantage of such an embodiment is that the manufacturing tolerances are able to be reduced in comparison with an otherwise additionally required alignment of an additional shaft.

The contactless transmission system between the stator and rotor has a plurality of pairs of mutually corresponding transmission elements, the mutually corresponding transmission elements of an individual pair being at least regionally situated across and at a distance from each other during a rotation of the rotor, so that a contactless reciprocal effect can occur between these transmission elements. In particular, this can involve transmission elements for the transmission of data, energy, and/or angles of rotation. Preferably, two of these pairs are used for a bidirectional data transmission (one pair in each case for the uplink and the downlink), one pair for the energy transmission (from the stator to the rotor), and one pair for the transmission of the angle of rotation. Mutually corresponding transmission elements can particularly involve a combination of a transmission element and a receiving element or correspondingly switched transceiver elements. A transmission element can be developed as one part or as a multi-part element.

In particular, the transmission elements utilized for an energy transmission can involve an inductively coupled transmitter-receiver combination. Inductively coupled, switchable transmitter-receiver combinations can be used for the data transmission.

A transmission of angles of rotation is able to be realized in particular in the form of a data transmission of an independently measured angle of rotation signal. However, an angle of rotation transmission can preferably also be measured in a direct manner via a position-encoded angle of rotation determination using the respective transmission elements. In this case, an ascertainment (and transmission) of the angle of rotation is able to be carried out directly via the mutual reciprocal effect of the associated transmission elements.

In order to avoid or reduce a mutual reciprocal effect between the respective pairs of transmission elements, these pairs are spatially separated from each other and situated along the radius of the rotating plate unit. A spatial separation along the radius of the rotating plate unit in particular means that a certain radius region within the disk-shaped rotating plate unit can be allocated to each pair. As a result, there is a difference in the distance of the individual transmission elements from the central axis.

The present invention integrates a contactless multi-channel transmission system into the mutually facing surfaces of a stator-rotor combination. This allows for the production of a highly integrated, space-saving, and cost-effective rotating plate unit. Because of the spatially separate placement of transmission elements along the radius of the rotating plate unit, they are largely able to be spatially decoupled from one another because virtually the entire inner surface of the rotating plate unit can be used for the distributed placement of the components. More specifically, in particular the components of the transmission system that induce especially strong mutual electrical interference are able to be placed particularly far from one another by a suitable distribution along the radius of the rotating plate unit. This allows for rapidly rotating rotating plate units including an integrated contactless transmission system. In addition, a bearing and/or a drive is/are able to be integrated into the units.

The transmission system preferably transmits in the same frequency range via the pairs of mutually corresponding transmission elements. For example, due to a distributed placement of the uplink and downlink components of a data transmission, the energy transmission and the transmission of the angle of rotation are able to operate next to one another in the same frequency range. This particularly allows for a simplified and cost-effective circuit development for the transmission system.

A spatially and/or materially structured screening region is preferably situated between at least two pairs of transmission elements of the transmission system along the radius of the rotating plate unit. This allows for an even greater suppression of electrical crosstalk between the individual components (in the radial direction). A spatially structured screening region in particular describes a wall-type spatial separation that is disposed between the pairs of transmission elements. In addition to a wall-type development of the separation, however, structures that are explicitly optimized with respect to the electrical demands can also form a spatially structured screening region. The screening regions can be developed both on the stator and the rotor. Another option is a development on the stator and rotor in which screening regions that engage with one another in a pointed, tooth-like or rounded manner are particularly preferred. The screening regions can be made from the same material as the stator and/or the rotor or include a deviating material for the further electrical optimization. Such a development of a screening region using a material that differs from the material of the stator or rotor is referred to as material structuring.

Preferably, at least one transmission element is situated on a flexible plastic circuit board (PCB) as a circuit board/interconnect device. This offers an advantage that the transmission element on the PCB is able to be combined in a compact and cost-saving manner with a corresponding driver circuit. Additional contacting steps that would otherwise be necessary can be omitted. Flexible PCBs have the additional advantage that they allow for savings in terms of weight. Another advantage of flexible PCBs in comparison with rigid PCBs is the option of allowing them to be adapted to or placed against the respective surface form of a carrier. This makes it easier to integrate them with other components.

For a high transmission rate, in particular during the data transmission, it is preferred to place the pairs of mutually corresponding transmission elements at the smallest possible vertical distance from one another within the rotating plate unit. Because of the rotation of the rotor and a spatially separated placement of the pairs of individual transmission elements of the transmission system along the radius of the rotating plate unit, the required accuracies in the mutual alignment of stator and rotor and also for the individual transmission elements are very high. The planarity is particularly important for the transmission elements situated in the direction of the outer edge of the rotating plate unit due to the greater circumference radius and a resulting increasing influence on tolerances in the alignment. However, deformations can occur quite easily, especially in the case of transmission elements on a rigid PCB. During the production of such a circuit board, particular attention should therefore be paid to ensure that no bending or distortion occurs, which causes increased work as well as a related high outlay in terms of material and costs. In contrast, flexible PCBs are able to be precisely adjusted to the shape of the surface of the particular carrier when applied to the stator or rotor. The thereby achievable planarity thus does not depend on the PCB itself but rather on the planarity of the carrier (rotor or stator) or on the quality of the application. This makes it possible to increase the accuracy in the production of a rotating plate to a considerable extent.

Preferably, the stator and/or rotor is/are made from a metallic material, a metallically coated plastic, and/or a plastic having metallic inserts. This allows for screening from electrical interference from the rotating plate or for screening of the rotating plate unit from external interference. In combination with a screening region situated at least between two pairs of transmission elements, electrical screening of the entire rotating plate unit and also between the individual functionalities of the transmission system can thus be carried out.

Preferably, a shaft, a ball bearing, and/or a rotatory drive element is/are situated along the central axis. The central axis defines the axis of rotation of the rotor relative to the stator. A rotor can be connected to a shaft along the central axis. A connection is able to be realized by bonding, in particular. A guidance for the shaft, which specifies the spatial position and thus the alignment of the rotor relative to the stator, is provided. A mutual alignment of the rotor and stator can also be realized by an appropriately placed ball bearing, which directly connects the stator and rotor to each other. A ball bearing is preferably a preloaded ball bearing. Such a connection can also be realized using a rotatory drive element (such as a direct drive) situated along the central axis of the rotating plate unit.

In addition, combinations of these elements are possible. More specifically, a shaft can be combined with a ball bearing, a rotatory drive element, or with both. A corresponding rotating plate unit having a particularly compact design is thereby able to be developed. By integrating a bearing and/or drive into the rotating plate unit, their reliability and service life in particular are able to be increased. For a rotating plate unit that is tightly sealed from dust, a preloaded ball bearing can particularly be used in the center of the unit, one half of the rotating plate unit (rotor or stator) being connected to the inner ring of the ball bearing, and the respective other half being connected to the outer ring.

The rotating plate unit preferably has a circumferential sealing lip or a sealing structure in the region of the outer edge. These components can help in protecting the interior of the rotating plate unit. The stator and rotor are therefore preferably developed and placed relative to each other in such a way that the outer edge of the rotating plate unit offers protection against the entry of foreign bodies into the rotating plate unit. This particularly can be achieved in that the surfaces of the stator and rotor that face each other have at least partially mutually engaging structuring for the purpose of providing sealing. The rotor and/or stator is/are preferably surface-structured in the region of the outer edge to the effect that at least one cavity region developed to accommodate transmission elements is formed in the interior of the rotating plate unit (i.e., in the region between the surfaces of the stator and rotor facing each other), this inner region of the rotating plate unit being able to be sealed in the area of the outer edge using a circumferential sealing lip or a sealing structure (edge structure).

An airgap is preferably located between at least one transmission element situated on the surface of the stator or the rotor and the respective surface. This can be especially advantageous for a data transmission because the lower dielectric constant of air (in comparison with the material of the stator or rotor) allows for higher frequencies (transmission rates). The development of an airgap is able to be realized using suitable surface structures on the stator or rotor. Preferred is a combination with transmission elements, which are situated on a flexible PCB. A calibration process for the structure specifically adapted thereto can be required.

The development of an airgap can preferably be realized in that a corresponding transmission element is held on the stator or the rotor using a surface structure which only partially braces the transmission element (or its PCB) and is developed as a spacer. It is additionally preferred that the surface region underneath the airgap is optimized to the electrical demands in terms of structure and/or material. As far as a structural and/or material optimization is concerned, reference is made to the statements regarding the spatially and materially structured screening regions. Because of adaptations of the surface that are structural (surface form) and/or material (different materials) in their nature, the effect of the airgap is able to be adapted in a corresponding manner.

A second aspect of the present invention relates to a LiDAR device that includes a rotating plate unit as described. More specifically, a LiDAR device according to the present invention can be a scanning LiDAR device having electro-optical components for outputting and receiving of LiDAR radiation.

Another aspect of the present invention relates to a method for producing a rotating plate unit as described. It includes the provision of a disk-shaped stator and a disk-shaped rotor according to the above statements; the application of the first transmission elements of the pairs of transmission elements to a highly precise fitting form in order to specify the distance between the transmission elements and to precisely fix the transmission elements in place with the stator applied to the fitting form; the application of the respective second transmission elements of the pairs of transmission elements to a highly precise fitting form in order to specify the distance between the transmission elements and to precisely fix the transmission elements in place with the rotor applied to the fitting form; and the combining of stator and rotor to form a rotating plate unit following the application and affixation of the respective transmission elements. The two steps of applying the transmission elements to the stator and rotor can be reversed and carried out in any desired sequence. The affixation of the transmission elements on the respective carrier (stator or rotor) can preferably be accomplished by bonding, soldering, welding, melting, or some other appropriate method of affixation.

The method according to the present invention is based on the use of a special fitting form for the precise spatial alignment of the individual transmission elements on the stator or rotor. Because of the spatially separated placement along the radius of the rotating plate unit according to the present invention, mutually corresponding transmission elements are placed on the rotor and stator at exactly the same absolute position on the respective surfaces. An individual alignment is too complex and imprecise. Using a fitting form, which offers high alignment precision (also known as an alignment or bonding tool), a desired alignment of the transmission elements on the rotor and stator can be achieved independently of each other. It is also possible to use a shared fitting form for the stator and rotor. Alternatively, fitting forms that are specially adapted to the rotor or stator and fitting forms that are precisely adapted to one another can be used as well.

The use of fitting forms makes it possible to considerably reduce the manufacturing tolerances when applying the individual transmission elements and to simplify their alignment. Via the fitting forms, the transmission elements are able to be precisely positioned and then be bonded to the respective carrier (rotor or stator). Such a procedure can result in higher transmission rates at lower costs, in particular during the data transmission. This is so because very small clearances between the respective transmission elements are required for high frequencies (transmission rates).

In addition to the smallest possible clearance between the stator and rotor, the most planar alignment of the individual transmission elements (or the respective PCBs) is to be provided. High demands are also made as far as a planar production of the transmission elements (or the respective PCB) is concerned. Transmission elements on flexible PCBs are preferably used in an effort to ensure the high planarity of the system. During bonding (or some other type of affixation such as soldering) using a fitting form, appropriate measures in the fitting form (e.g., attraction of the PCB through underpressure), flexible PCBs are able to be held in place at the respective locations on the stator or rotor in a particularly planar manner.

The combining of the stator and rotor to form a shared rotating plate unit also requires a high measure of accuracy, it being particularly preferred in this case that the surfaces of stator and rotor situated across from each other are aligned in parallel with each other, if possible. One possibility for reducing the tolerances during the manufacture is the use of an alignment step during the combining in which the two halves (stator and rotor) of the rotating plate unit are first precisely adjusted to a required distance by a mechanical and/or electronic measurement and the halves are subsequently permanently fixed in place relative to each other (e.g., by bonding) via a corresponding affixation process (for instance on a shaft, a ball bearing, and/or a rotatory drive element).

Example embodiments of the present invention are described in greater detail based on the drawings and the following description.

### BRIEF DESCRIPTION OF THE DRAWING

FIG. 1 is a schematic illustration of a rotating plate unit according to an example embodiment of the present invention.

FIG. 2 is a schematic illustration of the screening regions of a rotating plate unit according to an example embodiment of the present invention.

FIG. 3 is a schematic illustration of a rotating plate unit featuring an airgap between a transmission element and a carrier according to an example embodiment of the present invention.

FIG. 4 is a schematic illustration of the affixation of transmission elements using a fitting form according to an example embodiment of the present invention.

### DETAILED DESCRIPTION

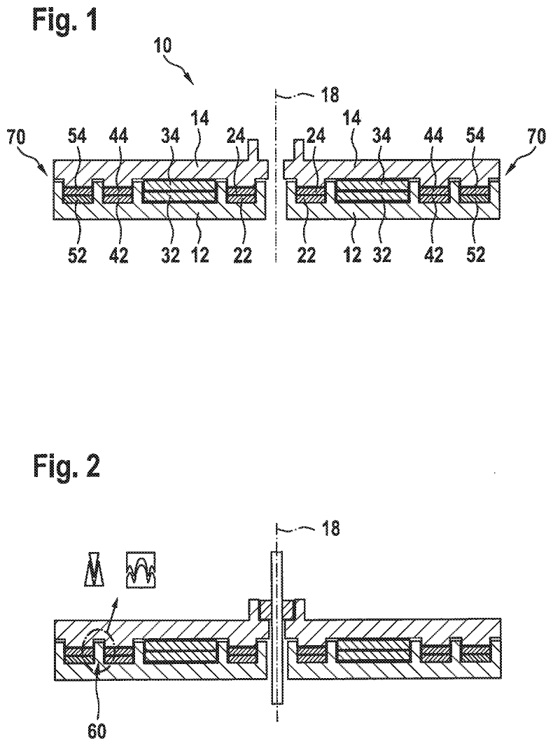

FIG. 1 is a schematic illustration of a rotating plate unit 10 according to an example embodiment of the present invention. Illustrated rotating plate unit 10 includes a disk-shaped stator 12 and a disk-shaped rotor 14, the disk-shaped surfaces of stator 12 and rotor 12 being situated parallel and at a distance from each other along a central axis 18. A contactless transmission system between stator 12 and rotor 14 has a plurality of pairs of mutually corresponding transmission elements 22, 24; 32, 34; 42, 44; 52, 54, where a respective first transmission element 22, 32, 42, 52 of a pair is situated on the surface of stator 12 facing rotor 14, and the associated second transmission element 24, 34, 44, 54 of the respective pair is situated on the surface of rotor 14 facing stator 12, mutually corresponding transmission elements 22, 24; 32, 34; 42, 44; 52, 54 of a pair being at least regionally situated across and at a distance from each other during a rotation of rotor 14. The pairs of individual transmission elements 22, 24; 32, 34; 42, 44; 52, 54 of the transmission system are situated in spatial separation from one another along the radius of the rotating plate unit. The mutually facing surfaces of stator 12 and rotor 14 are developed in structured form, these structures engaging with one another in rotating plate unit 10. In the illustrated embodiment, the individual transmission elements 22, 24; 32, 34; 42, 44; 52, 54 in essence are completely surrounded or enclosed at outer edge 70 by the combination of stator 12 and rotor 14.

FIG. 2 shows a schematic illustration of example embodiments of the screening regions of a rotating plate unit 10. The illustrated embodiment largely corresponds to the embodiment of a rotating plate unit 10 according to the present invention shown in FIG. 1. However, in contrast thereto, a shaft is shown in addition, which is situated along central axis 18 of rotating plate unit 10. Between two pairs of transmission elements (transmission elements 42, 44; 52, 54 in FIG. 1) of the transmission system, a spatially structured screening region 60 is emphasized along the radius of rotating plate unit 10. Corresponding screening regions 60 can also be situated between the other pairs of transmission elements. More specifically, spatially structured screening regions 60 are to be understood as wall-type spatial separations disposed between the pairs of transmission elements.

However, in addition to a wall-type development of the separation, structures that are explicitly optimized to the electrical demands can also form a spatially structured screening region 60. Screening regions 60 can be developed both on stator 12 and rotor 14. Also possible is a development on stator 12 and rotor 14, in which case screening regions that engage with one another in a pointed, tooth-like, or a rounded manner are particularly preferred (as shown in the further illustrations). Screening regions 60 can be made from the same material as stator 12 and/or rotor 14 or include a material that deviates therefrom for a further electrical optimization.

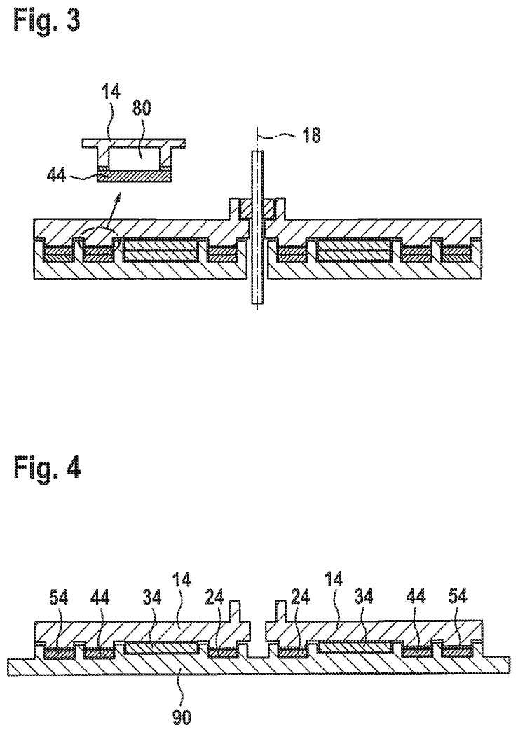

FIG. 3 shows a schematic illustration of an embodiment of a rotating plate unit 10, which features an airgap 80 between the transmission element 44 and a carrier (rotor 14). The illustrated embodiment corresponds to the embodiment of a rotating plate unit 10 according to the present invention as shown in FIG. 2 including a shaft that extends along central axis 18. By way of example, the marked region illustrates the position of an airgap 80, but this airgap can also be located underneath further or completely different transmission elements. As illustrated, the development of airgap 80 can preferably be realized in that a corresponding transmission element 44 is held in place on the respective carrier (rotor 14 or stator 12) using a surface structure that only partially braces the transmission element (or its PCB carrier) and is developed as a spacer.

FIG. 4 shows a schematic illustration of the way in which transmission elements (24, 34, 44, 54) are fixed in place using fitting form 90. To specify the distance between the individual transmission elements, the second transmission elements 24, 34, 44, 54 of the pairs of transmission elements in the illustration were applied to a highly precise fitting form 90. In addition, the illustration shows the way in which applied transmission elements 24, 34, 44, 54 are fixed in place with rotor 14 placed on fitting form 90. A corresponding illustration for the affixation on stator 12 has been omitted.

What is claimed is:

1. A rotating plate unit for a LiDAR device, the rotating plate unit comprising:
a disk-shaped stator;
a disk-shaped rotor, wherein disk-shaped surfaces of the stator and rotor are parallel to and at a distance from each other along a central axis; and
a contactless transmission system between the stator and rotor, the transmission system including a plurality of pairs of mutually corresponding transmission elements, wherein:
with respect to each of the pairs:
a first one of the transmission elements of the respective pair is situated on a surface of the stator facing the rotor;
a second one of the transmission elements of the respective pair is situated on a surface of the rotor facing the stator; and
first and second transmission elements of the respective pair are at least regionally situated across and at a distance from each other during a rotation of the rotor; and
the pairs are situated in spatial separation from one another along a radius of the rotating plate unit.

2. The rotating plate unit of claim 1, wherein the transmission system is configured to perform a transmission in a same frequency range for all of the pairs.

3. The rotating plate unit of claim 1, wherein, for at least two adjacent ones of the pairs, a spatially and/or materially structured screening region is situated between the pairs along the radius of the rotating plate unit.

4. The rotating plate unit of claim 1, wherein the stator and/or the rotor is made from a metallic material, a metallically coated plastic, and/or a plastic having metallic inserts.

5. The rotating plate unit of claim 1, further comprising at least one of a shaft, a ball bearing, and a rotatory drive element is situated along the central axis.

6. The rotating plate unit of claim 1, wherein the rotating plate unit has a circumferential sealing lip or a sealing structure in a region of an outer edge of the rotating plate unit.

7. The rotating plate unit of claim 1, wherein at least one transmission element is situated on a flexible PCB.

8. The rotating plate unit of claim 1, wherein an airgap is located between (a) at least one transmission element situated on the surface of the stator or the rotor and (b) the respective surface.

9. A LiDar device comprising a rotating plate unit, wherein:
the rotating plate unit includes:
a disk-shaped stator;
a disk-shaped rotor, wherein disk-shaped surfaces of the stator and rotor are parallel to and at a distance from each other along a central axis; and
a contactless transmission system between the stator and rotor, the transmission system including a plurality of pairs of mutually corresponding transmission elements;
with respect to each of the pairs:
a first one of the transmission elements of the respective pair is situated on a surface of the stator facing the rotor;
a second one of the transmission elements of the respective pair is situated on a surface of the rotor facing the stator; and
first and second transmission elements of the respective pair are at least regionally situated across and at a distance from each other during a rotation of the rotor; and
the pairs are situated in spatial separation from one another along a radius of the rotating plate unit.

10. A method for producing a rotating plate unit the method comprising:
providing a disk-shaped stator and a disk-shaped rotor;
applying first transmission elements of the pairs of transmission elements to a fitting form in order to specify a distance between the first transmission elements and to precisely fix the first transmission elements in place relative to the stator with an application of the stator to the fitting form;
applying second transmission elements to the fitting form in order to specify a distance between the second transmission elements and to precisely fix the second transmission elements in place relative to the rotor with an application of the rotor to the fitting form; and
combining the stator and rotor to form the rotating plate unit following the fixation of the transmission elements to the stator and rotor, respectively;
wherein, in the formed rotating plate unit:
disk-shaped surfaces of the stator and rotor are parallel to and at a distance from each other along a central axis;
the first and second transmission elements are arranged in a plurality of pairs that each includes one of the first transmission elements on the stator and one of the second transmission elements on the rotor at least regionally situated across and at a distance from the first transmission element of the respective pair during a rotation of the rotor; and
the pairs are situated in spatial separation from one another along a radius of the rotating plate unit.

11. The method of claim 10, wherein the fitting form is a single fitting form used for both the first and second transmission element.

12. The method of claim 10, wherein the fitting form includes a first fitting form used for the first transmission elements and a second fitting form used for the second transmission elements.
